(19) United States
(12) Patent Application Publication
(10) Pub. No.: US 2007/0119782 A1
(43) Pub. Date: May 31, 2007

(54) Method and system for controlling corrosivity of purified water

(76) Inventors: James Rulon Young Rawson, Clifton Park, NY (US); Raul Eduardo Ayala, Clifton Park, NY (US)

Correspondence Address: Patrick S. Yoder;FLETCHER YODER, P.O. Box 692289, Houston, TX, 77269-2289, US

(21) Appl. No.: 11/291,377

(22) Filed: Nov. 30, 2005

(51) Int. Cl. B01D 61/00

(52) U.S. Cl. 210/650; 210/259; 210/258

(57) ABSTRACT

Methods and systems for purifying water are provided in which the treated water is softer than the influent water and is mildly corrosive or non-corrosive. In one embodiment, the influent water is treated using a membrane configured to soften the treated water relative to the influent water while leaving the treated water mildly corrosive or non-corrosive. In alternative embodiments, the influent water is treated using a membrane to generate the treated water. The treated water is mixed in a mixing device with a stream of untreated water such that the resulting stream of mixed water is softer than the influent water and is mildly corrosive or non-corrosive.

### BACKGROUND

The invention relates generally to water purification and, more specifically, to controlling corrosivity of metallic pipes by water purified using a purification system, such as a membrane-based water purification system.

Residential water purification systems are commonly used to purify water for drinking or other household uses. Such systems typically remove contaminants, solids, chemicals, or other undesirable impurities which may be present in a municipal water supply or private well water. Whole home systems may be useful for providing pure water to an entire home, as opposed to merely purifying the water at a single point-of-use faucet or tap. Such whole home systems typically operate by filtering or otherwise purifying the water at the point of entry into the house, thereby providing purified water throughout the house.

Point of entry water purification systems may filter water using reverse osmosis or nanofiltration membranes. Such membranes are typically highly efficient at removing impurities. In particular, a typical reverse osmosis or a nanofiltration membrane may filter out nearly all of the total dissolved solids (including hardness and alkalinity) from the water entering the house. For example, the purified water generated using either a reverse osmosis or nanofiltration membrane may contain less than 10 mg/L of total dissolved solids and/or less than one grain per gallon of total hardness (i.e., less than 17.1 mg/L of calcium carbonate (CaCO₃)).

The resulting purified water is so pure that it is unlikely to form scale deposits on the surfaces of the copper or other similar metallic plumbing within the house. Likewise, the absence of significant alkalinity in the purified water precludes oxidation, i.e., passivation, of the interior surfaces of such copper or other metallic plumbing. In addition the absence of alkalinity may also cause a drop in pH, which may cause corrosion of the same types of plumbing. The absence or near absence of scale and/or passivation on the interior surfaces of copper or other metallic plumbing may be problematic, however. In particular, the absence or near absence of scale and/or passivated surfaces allow the water to react with the metallic surfaces, thereby increasing the incidence of corrosion in the copper or similar metallic plumbing. Such corrosion may reduce the life expectancy of plumbing or appliances through which the purified water passes. Therefore, it may be desirable to reduce the corrosiveness of water treated by such purification systems.

### BRIEF DESCRIPTION

In one embodiment, a water purification system is provided. The water purification system includes a membrane configured to treat a stream of influent water. The resulting stream of treated water is softer than the influent water and is mildly corrosive or non-corrosive. A corresponding method is also provided.

In a second embodiment, a water purification system is provided. The water purification system includes a membrane configured to treat a portion of a stream of influent water to generate a stream of treated water. Also includes is a mixing device configured to mix the stream of treated water and a stream of untreated water. The resulting stream of mixed water is softer than the influent water and is mildly corrosive or non-corrosive. A corresponding method is also provided.

In a third embodiment, a kit for modifying a water purification system is provided. The kit includes a membrane configured to treat influent water. The treated water is softer than the influent water and is mildly corrosive or non-corrosive.

### DRAWINGS

These and other features, aspects, and advantages of the present invention will become better understood when the following detailed description is read with reference to the accompanying drawings in which like characters represent like parts throughout the drawings, wherein:

FIG. 1 depicts an embodiment of an exemplary water purification system, in accordance with aspects of the present technique;

FIG. 2 depicts a second embodiment of an exemplary water purification system, in accordance with aspects of the present technique; and

FIG. 3 depicts a third embodiment of an exemplary water purification system, in accordance with aspects of the present technique.

### DETAILED DESCRIPTION

As discussed herein, the corrosiveness of water is related to the likelihood of scale formation and/or surface passivation on copper (or other metallic) surfaces, such as in pipes, conduits and so forth. In general, the less likely that scale formation and/or passivation will occur, the more corrosive the water to the metallic surfaces. The likelihood of scale formation and/or passivation, in turn, is related to certain chemical parameters of the water in question. For example, properties such as water hardness (typically measured by the amount of calcium carbonate present), alkalinity, pH, and total dissolved solids (TDS) are related to the likelihood of scale formation and/or passivation and, therefore, to water corrosiveness.

Various indices are typically employed by those of skill in the art to characterize corrosiveness based on these and other parameters. Examples of such indices include the Langelier Saturation index, the Ryznar Stability index, the Puckorius Scaling index, the Larson-Skold index, the Stiff-Davis index, and the Oddo-Tomson index. As a representative example, the Langelier index may be calculated, for a given temperature and dissolved oxygen content, as:
LSI=pH−pHₛ (1)
where pH is the log of the concentration (moles/L) of hydrogen ion in the water and pHₛ is the pH at saturation in calcium or calcium carbonate. The term pHₛ may in turn be represented as:
pHₛ=(pCa+pAlk+(pK′2−pK′s)) (2)
where pCa is the log of the concentration (moles/L) of calcium and pAlk is the equivalents of the total alkalinity per liter (equivalents/L) in the water and where (pK′2−pK′s) is a tabulated value which varies as a function of TDS and temperature of the water. In practice, the term pHₛ may also be determined as:
pHₛ=(9.3+A+B)−(C+D) (3)
where A=(Log₁₀[TDS]−1)/10, B=(13.12×Log₁₀(° C.+273))+34.55), C=(Log₁₀[Ca²⁺ as CaCO₃])−0.4, and D=Log₁₀([M alkalinity as CaCO₃]).

In practice, the LSI may be used as an indicator of the likelihood of scale formation, and thus of the corrosivity of water on metallic pipes. For example, an LSI of −4 or less is typically indicative of severe corrosivity; an LSI of −2 to −3 is typically indicative of moderate corrosivity; and LSI's between −2 and −1 and between −1 and 0 are generally indicative of mild to very mild corrosivity, respectively. Conversely, an LSI greater than 0 is typically indicative that the respective water is generally non-corrosive.

With these factors in minds, it is possible to control for one or more of the parameters that contribute to water corrosivity while still purifying the water so that it is “soft” (i.e., contains less than three grains of calcium carbonate per gallon of water) or otherwise substantially reduced in hardness. For example, the present techniques provide for the purification of water such that the softened water is generally non-corrosive (i.e., has an LSI greater than −0.5) or only mildly corrosive (i.e., has an LSI greater than −2) without adjusting pH or adding chemicals. The present technique reduces corrosivity by retaining a degree of hardness, alkalinity, and/or total dissolved solids in the effluent water, though not so much that the effluent water is not soft.

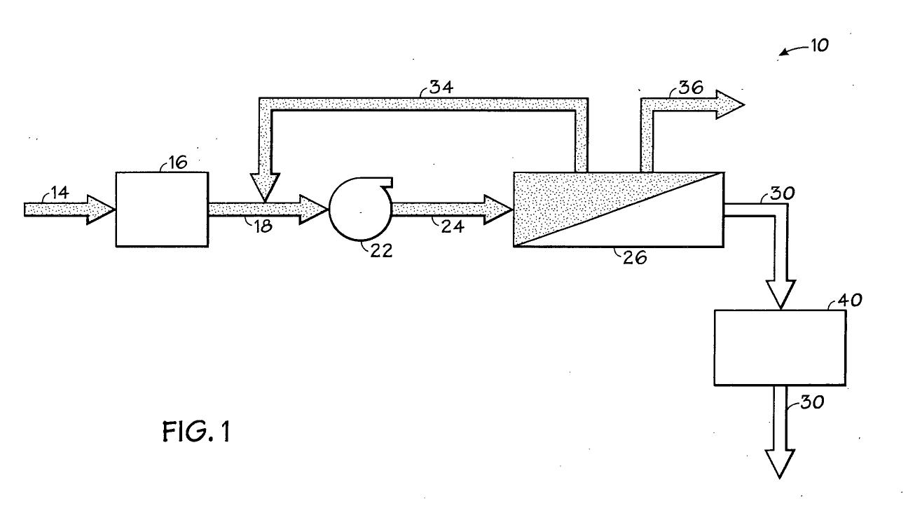

For example, in one embodiment a membrane-based water purification system 10 is provided, as depicted in FIG. 1. In the depicted embodiment, an influent flow 14 of unpurified or hard water is treated. The influent flow passes through a filter 16 of activated charcoal to produce a filtered flow 18 of water. As will be appreciated by those of ordinary skill in the art, filtration through activated charcoal may be useful for removing certain types of impurities, such as chlorine and/or organic chemicals which might impart an odor or color to the water. While the depicted embodiment includes activated charcoal filtration, one of ordinary skill in the art will appreciate that such filtration is optional in a process for softening water, as described herein.

The filtered flow 18 (or influent flow 14 in the absence of a charcoal filter 16) is propelled by pump 22 or other motive device. The resulting pumped water 24 has a positive pressure when in contact with one or more membranes 26 through which water and a controlled level of hardness, alkalinity, and/or total dissolved solids pass. In one embodiment, the resulting treated water 30 is generally non-corrosive, i.e., has an LSI greater than −0.5. In another embodiment, the resulting purified water 30 is only mildly-corrosive, i.e., has an LSI greater than −2. In such embodiments, the purified water 30 is also soft (i.e., has less than 3 grains of calcium carbonate per gallon of water) or is otherwise reduced in hardness relative to the influent flow 14.

In one implementation, the membrane 26 is a reverse osmosis membrane that removes sufficient total dissolved solids, hardness, and/or alkalinity so that the treated water 30 is softened, but not so much that the treated water 30 is more than mildly corrosive. In another implementation, the membrane 26 is a low-energy reverse osmosis membrane, i.e. a “loose” reverse osmosis membrane, that allows a controlled amount of total dissolved solids, hardness, and/or alkalinity through to obtain softened water which is mildly or non-corrosive. In still another implementation, the membrane 26 is a nanofiltration membrane that allows a controlled amount of total dissolved solids, hardness, and/or alkalinity through with similar result. As will be appreciated by those of ordinary skill in the art, the membrane 26 may be any membrane or combination of membranes that removes sufficient total dissolved solids, hardness, and/or alkalinity so that the treated water 30 is softened, but not so much that the treated water 30 is more than mildly corrosive.

A recycle stream 34 of water that has not passed through the membrane may also be provided, as depicted in FIG. 1. The recycle stream 34 may transport water upstream between the filter 16 and the pump 22 for reintroduction to the treatment process. However, as will be appreciated by those of ordinary skill in the art, the recycle stream 34 may reintroduce water at any point upstream of the membrane 26. In addition, a concentrate stream 36 may be provided in which water that has not passed through the membrane is output to a sewer or other discard line.

The treated water 30 may be stored in a pressure or storage tank 40 which acts to provide variable flow control. In particular, the treated water 30 stored in the tank 40 may be pressurized so that water may be dispensed downstream without the pump 22 being activated. In this manner, the pump 22 and membrane 26 may used to fill the tank 40 when the tank 40 reaches a set level of depletion, but need not be used continuously. As needed, the treated water 30 is released from the tank 40 for downstream uses.

In an implementation of the above embodiment, a nanofiltration membrane was employed as the membrane 26 to partially remove the hardness from an influent stream 14. The influent stream 14 had a pH of 7.6, a hardness of 10.7 grains per gallon, a TDS of approximately 260 mg/L, and 170 mg/L alkalinity (as CaCO₃). In this implementation, the effluent, treated water had a pH of 6.9, a hardness of 3.6 grains per gallon, a TDS of approximately 125 mg/L and a corresponding LSI of −1.93. In contrast, the same influent stream 14 was treated with a reverse osmosis membrane configured to remove substantially all hardness. In this treatment, the effluent water had a pH of 6.6, a hardness of 0.1 grains per gallon, a TDS of approximately 110 mg/L, and a corresponding LSI of −5.28. In addition, qualitative observations for green copper oxide in the effluent water indicated that copper fittings used in the reverse osmosis membrane implementation were corroded while no such green copper oxide was observed in the nanofiltration implementation.

While the preceding discussion relates to a whole-system implementation of a membrane 26, one of ordinary skill in the art will appreciate that the membrane 26 may be provided as an upgrade, modification or enhancement to an existing water purification system. In such an implementation, an upgrade kit including the membrane 26 may be provided. The membrane 26 from the upgrade kit may then be used to replace the membrane of an existing water purification system. In this manner, the functionality described above with regard to reducing the corrosiveness of treated water may be obtained without replacing the entire water purification system.

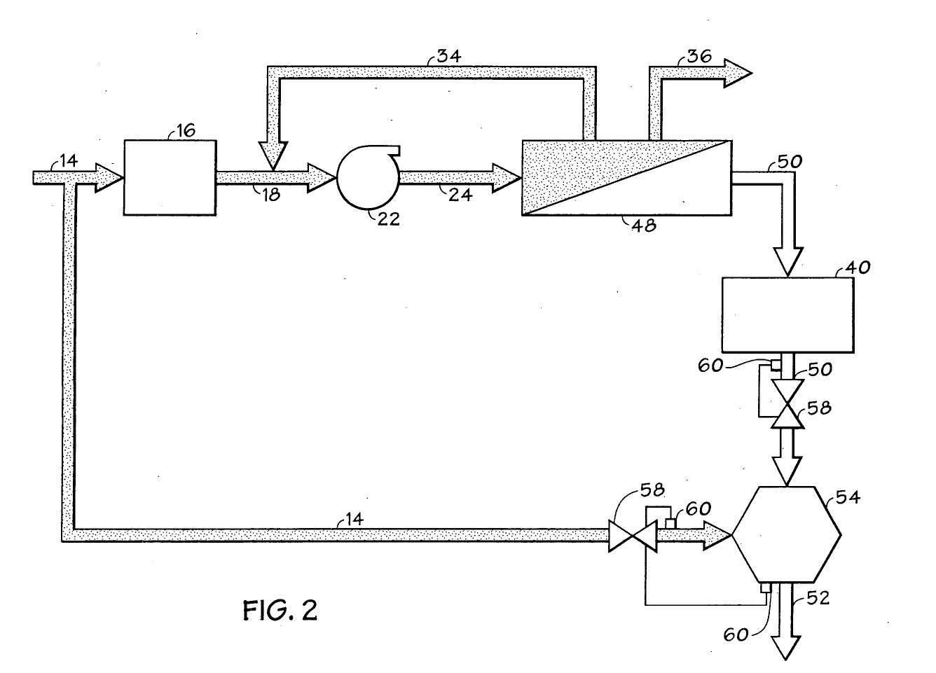

In an alternative embodiment, depicted in FIG. 2, the membrane 48 may remove sufficient total dissolved solids, hardness, and/or alkalinity to not only soften the softened water 50 but to also render the softened water 50 more than mildly corrosive. The softened water 50 passes through a pressure and/or storage tank 40 from which it is distributed for downstream uses, as described above. Prior to distribution, however, the softened water 50 is blended or otherwise combined with a portion of the influent flow 14 to impart the desired degree of softness and non-corrosivity to the mixed stream 52. In the depicted embodiment, the mixing of the softened water 50 and the influent stream 14 occurs in a mixing device 54, such as a mixing chamber, a static mixer pipe insert, and so forth. In other embodiments, the mixing process may be accomplished in the downstream pipes or conduits themselves, in multiple mixing chambers, or in any other structure suitable for mixing the softened and influent streams. Further, though the embodiment of FIG. 2 depicts the mixing process occurring downstream of the pressure/storage tank 40, in other embodiments the mixing process may occur upstream of the tank 40 or at any other location within the system 10 suitable for such mixing.

In one embodiment, the blend ratio of the softened water 50 and the influent stream 14 is set at the time of installation based on the properties (pH, hardness, alkalinity, TDS) of the influent stream 14 and of the softened water 50 and based on the desired degree of softness and non-corrosiveness in the mixed stream 52. In other embodiments, the ratio of the softened water 50 and the influent stream 14 may be adjusted. For example, in the depicted embodiment, a flow control valve 58 is provided in the influent flow line. Flow control valves 58 may control the flow of influent water 14 and/or softened water 50 to the mixing device 54 in response to the outputs of one or more sensors 60 measuring properties of the respective water at one or more locations within the system 10.

For example, one or more sensors 60 may monitor the conductivity of the softened water 50, the influent water 14, and/or the mixed stream 52. Based on the conductivity, the TDS of the respective water may be determined, such as via a suitable algorithm, and used as a surrogate measure of corrosivity. Therefore, based on the measured TDS, a desired ratio of softened water 50 and influent water 14 may be determined, such as via a look-up table or algorithmic calculation. Based on the desired ratio, flow control valves 58 may be set to meter the desired amount of influent water 14 and/or softened water 50 into the mixing device 54 to obtain the desired ratio of softened water 50 and influent water 14. As one of ordinary skill in the art will appreciate, the desired ratio may be obtained by metering the amount of influent water 14, the amount of softened water 50, or the amount of both the softened and influent water into the mixing device 54.

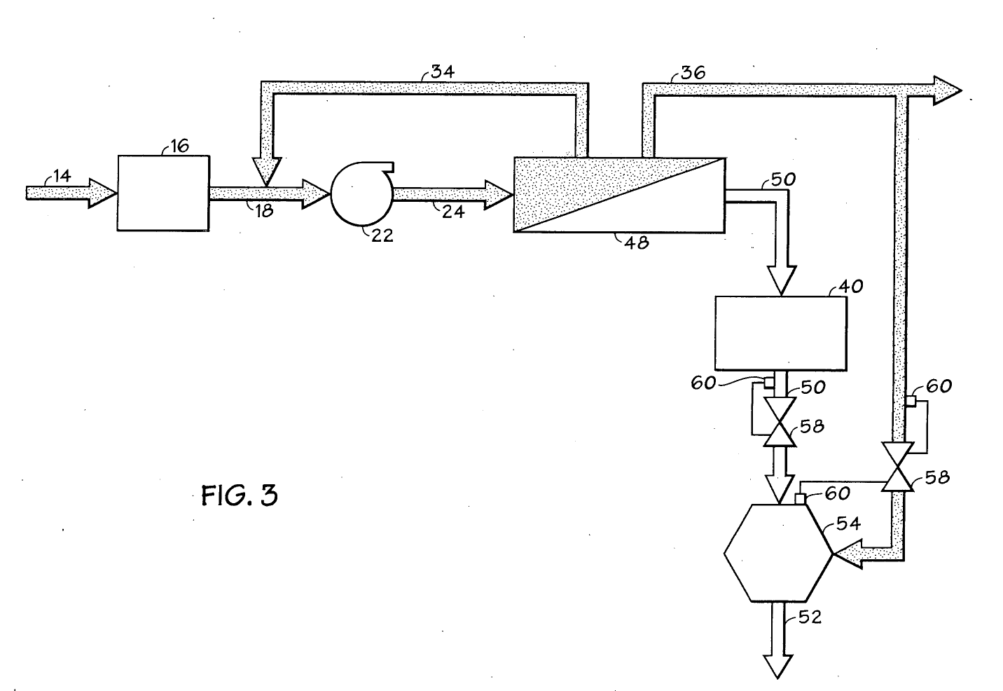

In an alternative embodiment, depicted in FIG. 3, the softened water 50 is instead mixed with water from the concentrate stream 36 to obtain the desired degree of softness and non-corrosivity in the mixed stream 52. The concentrate stream 36 (and/or the softened water 50) may be metered into the mixing device via one or more sensors 60 and flow control valves 58, as discussed above, to achieve the desired ratio of softened water 50 and concentrate water 36. Alternatively, the ratio of concentrate water 36 to softened water 50 may be set, such as during installation, based upon the hardness, pH, alkalinity, and/or TDS of the concentrate stream 36 and/or the softened water 50.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A water purification system, comprising:
a membrane configured to treat a stream of influent water such that a resulting stream of treated water is softer than the influent water and is mildly corrosive or non-corrosive.

2. The water purification system of claim 1, wherein the membrane comprises at least one of a reverse osmosis membrane, a low-energy reveres osmosis membrane, or a nanofiltration membrane.

3. The water purification system of claim 1, wherein the treated water has a Langelier saturation index greater than −0.5.

4. The water purification system of claim 1, wherein the treated water has a Langelier saturation index greater than −2.0.

5. The water purification system of claim 1, wherein the treated water has less than 3 grains of calcium carbonate (CaCO₃) per gallon of water.

6. The water purification system of claim 1, further comprising a pump upstream of the membrane.

7. The water purification system of claim 1, further comprising a activated charcoal filter upstream of the membrane.

8. The water purification system of claim 1, further comprising a storage tank downstream of the membrane.

9. A water purification system, comprising:
a membrane configured to treat a portion of a stream of influent water to generate a stream of treated water; and
a mixing device configured to mix the stream of treated water and a stream of untreated water such that a resulting stream of mixed water is softer than the influent water and is mildly corrosive or non-corrosive.

10. The water purification system of claim 9, wherein the stream of untreated water comprises an untreated portion of the stream of influent water.

11. The water purification system of claim 9, wherein the untreated water is obtained upstream of the membrane.

12. The water purification system of claim 9, wherein the untreated water is obtained from a concentrate stream that is otherwise discarded.

13. The water purification system of claim 9, wherein the mixing device comprises at least one of a mixing chamber or a static mixer pipe insert.

14. The water purification system of claim 9, wherein the membrane comprises a reverse osmosis membrane.

15. The water purification system of claim 9, wherein the mixed water has a Langelier saturation index greater than −0.5.

16. The water purification system of claim 9, wherein the mixed water has a Langelier saturation index greater than −2.0.

17. The water purification system of claim 9, wherein the effluent mixed has less than 3 grains of calcium carbonate (CaCO₃) per gallon of water.

18. The water purification system of claim 9, further comprising a pump upstream of the membrane.

19. The water purification system of claim 9, further comprising an activated charcoal filter upstream of the membrane.

20. The water purification system of claim 9, further comprising a storage tank downstream of the membrane.

21. A kit for modifying a water purification system, comprising:
a membrane configured to treat influent water such that the treated water is softer than the influent water and is mildly corrosive or non-corrosive.

22. The kit of claim 21, wherein the membrane comprises one of a reverse osmosis membrane, a low-energy reverse osmosis membrane, or a nanofiltration membrane.

23. The kit of claim 21, wherein the membrane allows sufficient hardness and/or alkalinity through such that the treated water has a Langelier saturation index greater than −0.5.

24. The kit of claim 21, wherein the membrane allows sufficient hardness and/or alkalinity through such that the treated water has a Langelier saturation index greater than −2.0.

25. The kit of claim 21, wherein the membrane allows less than 3 grains of calcium carbonate (CaCO₃) per gallon of water through.

26. A method for treating water, comprising:
passing a stream of influent water through a membrane such that a resulting stream of treated water is softer than the influent water and is mildly corrosive or non-corrosive.

27. The method of claim 26, wherein passing the stream of influent water through the membrane comprises passing the stream of influent water through at least one of a reverse osmosis membrane, a low-energy reveres osmosis membrane, or a nanofiltration membrane.

28. A method for treating water, comprising:
passing a portion of a stream of influent water through a membrane to generate a stream of treated water; and
mixing the stream of treated water with a stream of untreated water such that a resulting stream of mixed water is softer than the influent water and is mildly corrosive or non-corrosive.

29. The method of claim 28, wherein mixing the stream of treated water with the stream of untreated water comprises mixing the stream of treated water with an untreated portion of the stream of influent water.

30. The method of claim 28, wherein mixing the stream of treated water with the stream of untreated water comprises mixing the stream of treated water with a concentrate stream.
